(19) United States
(12) Patent Application Publication
(10) Pub. No.: US 2026/0203463 A1
(43) Pub. Date: Jul. 16, 2026

(54) SOLID OBJECT PROCESSING WITH ADVANCED CRACK MODELING

(71) Applicants: BOARD OF REGENTS, THE UNIVERSITY OF TEXAS SYSTEM, Austin, TX (US); The Government of the United States as represented by the Secretary of the Air Force, Wright-Patterson AFB, OH (US)

(72) Inventors: Endel IARVE, Colleyville, TX (US); Michael Keith BALLARD, Oakwood, OH (US)

(73) Assignees: BOARD OF REGENTS, THE UNIVERSITY OF TEXAS SYSTEM, Austin, TX (US); The Government of the United States as represented by the Secretary of the Air Force, Wright-Patterson AFB, OH (US)

(21) Appl. No.: 19/449,728

(22) Filed: Jan. 15, 2026

Related U.S. Application Data
(60) Provisional application No. 63/745,757, filed on Jan. 15, 2025.

(51) Int. Cl. G06F 30/17; G06F 30/23

(52) U.S. Cl. CPC G06F 30/17; G06F 30/23

(57) ABSTRACT

Methods for manufacture and preventative maintenance of material solid objects which are potentially-susceptible to cracking and crack-induced fracture. For manufacturing, embodiments of the invention optimize design of the material solid object to minimize the occurrence and growth of cracking; and for maintenance, embodiments of the present invention predict the timing and location of future growth of an existing cracking in the material solid object. A Finite Element Method model is constructed and analyzed, wherein an advanced extended Finite Element Model features twin nodes and element twinning to allow arbitrary interacting cracks to be efficiently modeled and analyzed for crack growth.

### CROSS-REFERENCE TO RELATED APPLICATION

This application claims the priority benefit of U.S. Provisional Application No. 63/745,757, filed Jan. 15, 2025, the entire contents of which are hereby incorporated by reference.

### STATEMENT OF GOVERNMENTAL SUPPORT

This invention was made with government support under FA8650-19-C-5212 awarded by the Air Force Research Laboratory (AFRL). The government has certain rights in the invention.

### FIELD

The field of the present invention is the manufacturing and maintenance of solid objects aided by modeling analysis and optimization of material processing operations.

### BACKGROUND

The phenomenon of crack formation, propagation, and growth in solid materials is a significant factor in undermining the reliability of manufactured parts as well as structures. Considerable work has been done in this field towards understanding the dynamics of cracking and predicting its effects.

Modeling arbitrary three-dimensional crack networks in solids is thus an important part of performance prediction for solid materials of manufactured objects and structures. The behaviors of crack networks differ significantly, depending on the materials under consideration and the stress loading to which they are subjected. Solid objects can exhibit one or more cracks which may merge or branch, especially under thermal and/or dynamic stresses, and can result in fracturing, disintegration, delamination, or other material failure of the objects and structures.

Presently, there are several classes of techniques for modeling and analyzing crack phenomena, with the aim of improving the manufacturing and maintenance processes of material solid objects serving as parts, structures, and assemblies. Unfortunately, currently-available models fail to address certain critical factors found in actual physical cracking. In particular, popular and successful formalisms for modeling crack growth and propagation in materials rely on the Finite Element Method (FEM) and its extensions (X-FEM) for creating mesh models of physical objects. Currently, however, there are limitations to existing X-FEM mesh models. For example, despite significant development in crack analysis and prediction using X-FEM models, there is presently no X-FEM framework for handling arbitrary crack interaction, such as crack growth where separate cracks merge through crack growth and spreading. It would thus be highly desirable to have an advanced Extended Finite Element Method mesh model for use in product manufacturing and maintenance processes, in which arbitrary crack interaction is taken into account. This goal is met by embodiments of the present invention.

### SUMMARY

Embodiments of the present invention provide new and improved methods for manufacture and preventative maintenance of material solid objects and structures which are potentially-susceptible to cracking and crack-induced fracture. For manufacturing, embodiments of the invention optimize design of material solid objects to minimize the occurrence and growth of cracking; and for maintenance, embodiments of the present invention predict the timing and location of future growth of existing cracking in material solid objects and structures.

To enable the prediction of crack growth patterns and the optimization of design to minimize the effects of cracking, the present invention provides a modeling formalism based on a novel extension and enrichment of the well-known Finite Element Method, which allows improved modeling of arbitrary three-dimensional interacting crack networks.

### BRIEF DESCRIPTION OF THE DRAWINGS

The subject matter disclosed may best be understood by reference to the following detailed description when read with the accompanying drawings in which:

FIG. 1A conceptually illustrates the organizational blocks of a manufacturing process assisted by an advanced Extended Finite Element Method model according to an embodiment of the present invention, to optimize the manufacturing design for minimizing the effects of cracking.

FIG. 1B conceptually illustrates the organizational blocks of a preventative maintenance process assisted by an advanced Extended Finite Element Method model according to an embodiment of the present invention, to more effectively deal with the effects of cracking.

FIG. 2A schematically illustrates features of the novel extensions of the Finite Element Method according to an embodiment of the present invention, which enable the modeling and analysis of arbitrary interacting cracks in a material solid object.

FIG. 2B conceptually illustrates recursive method steps in a hierarchical node-twinning procedure for analyzing intersecting cracks in a material solid object or structure, involving nodes of a Finite Element model, according to an embodiment of the present invention.

FIG. 2C conceptually illustrates recursive method steps in a hierarchical element-twinning procedure for analyzing intersecting cracks in a material solid object or structure, involving elements of a Finite Element model, according to an embodiment of the present invention.

FIG. 3 shows a flowchart of a manufacturing method according to an embodiment of the present invention, and also schematically shows modules related to the manufacturing process illustrated in FIG. 1A.

FIG. 4 shows a flowchart of a preventative maintenance method according to an embodiment of the present invention, and also schematically shows modules related to the preventative maintenance process illustrated in FIG. 1B.

For simplicity and clarity of illustration, elements shown in the figures are not necessarily drawn to scale, and the dimensions of some items may be exaggerated relative to other items. In addition, reference numerals may be repeated among the figures to indicate corresponding or analogous items.

### DETAILED DESCRIPTION

Following is a detailed disclosure of embodiments of the present invention as directed to a process for manufacturing a material solid object optimized to minimize the effects of cracking, and to a preventative maintenance process for a material sold object or structure exhibiting a crack, to predict the extent and timing of cracking growth for optimally finalizing the preventative maintenance process.

It is well-understood that practical use of the Finite Element Method requires the use of a data processor executing appropriate computer software to construct and analyze FEM models. Accordingly, for the benefit of those who are skilled in the art as being familiar with the Finite Element Method, an Appendix is incorporated herein by reference to a priority document (U.S. Provisional Application No. 63/745,757, filed January 15, 2025) as an integral part of the present disclosure. The Appendix filed with U.S. Provisional Application No. 63/745,757 and incorporated herein by reference covers detailed information concerning node twins and twinned elements, which are the novel and innovative features of the present invention enabling the modeling and analysis of arbitrarily-interacting cracks in a material solid object.

The term “material solid object” herein denotes such objects and structures, including items of manufacture. In particular, it includes items of manufacture and construction which are potentially susceptible to cracking and failure by fracture.

The term “solid material” herein covers, without limitation thereto, materials generally referred to in the field of materials as “brittle” and “quasi-brittle”. The term “solid material” herein also covers, without limitation thereto, materials classified as “composite materials” as well as materials classified as “laminates”.

In an embodiment of the present invention, a material solid object itself stands alone. In a related embodiment, a material solid object is a component within an assembly. According to further related embodiments, assemblies include, but are not limited to:
structures, non-limiting examples of which include:
   buildings;
   paved roads and paved road surfaces;
   bridges;
   overpasses;
   tunnels;
   towers; and
   monuments;
systems;
devices;
machines; and
vehicles, non-limiting examples of which include:
   terrestrial vehicles;
   railway vehicles;
   cable vehicles;
   amphibious vehicles;
   autonomous vehicles;
   cargo vehicles;
   lifting carriers;
   hovercraft;
   aircraft;
   launch vehicles;
   spacecraft;
   waterborne vessels;
   ships;
   submarine vessels; and
   submersible vessels.

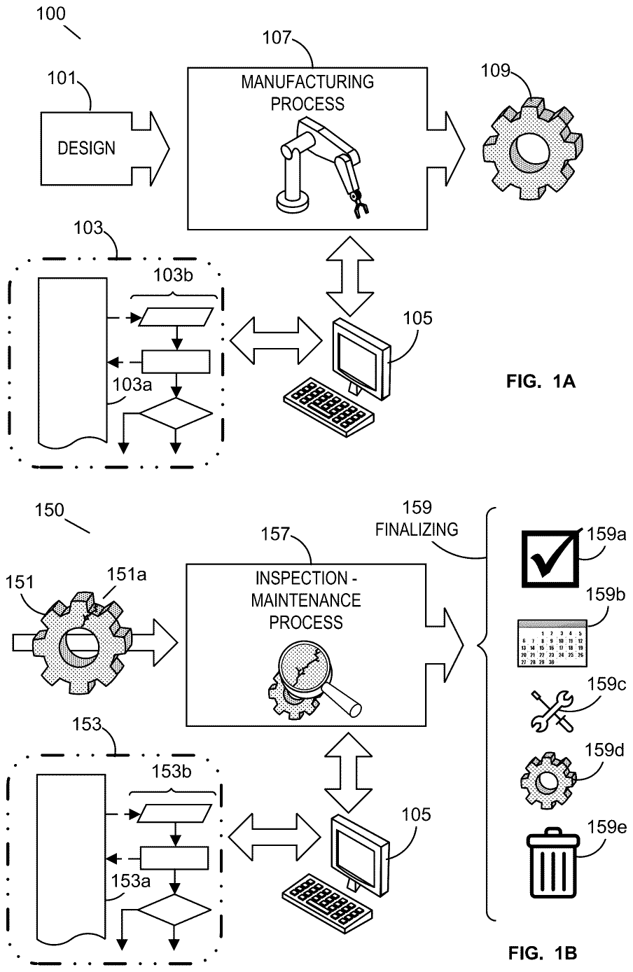

FIG. 1A conceptually illustrates the organizational blocks of a manufacturing process 100 assisted by an advanced Extended Finite Element Method model 103a according to an embodiment of the present invention, to optimize the manufacturing design for minimizing the effects of cracking. Accompanying model 103a are data processing modules and operations 103b, all of which are included in a package 103 accessed and executed by a data processing system 105 to conduct a manufacturing process 107 to manufacture a material solid object 109 as a manufactured item.

FIG. 1B conceptually illustrates the organizational blocks of an inspection and preventative maintenance process 150 assisted by an advanced Extended Finite Element Method model 153a according to an embodiment of the present invention, to carry out an effective preventative maintenance process for assessing the effects of a detected crack 151a in a material solid object 151. In a related embodiment material solid object 151 is a component of an assembly (not shown). Accompanying model 153a are data processing modules and operations 153b, all of which are included in a package 153 accessed and executed by data processing system 105 to conduct a preventative maintenance process 157 on cracked material solid object 151. In a preventative maintenance finalizing 159, the results of an analysis and assessment from package 153, inspection-preventative maintenance process 157 are taken into account when making a finalizing disposition to perform one or more of:
a certification 159a that object 151 is suitable;
a scheduling 159b of a follow-up inspection and preventative maintenance operation on object 151;
a restorative procedure 159c to treat/repair crack 151a to render object 151 suitable;
a replacement procedure 159d to replace cracked object 151 with a new object; and
a discarding procedure 159e, wherein the entire assembly (of which object 151 is a component) is scrapped. This option is typically chosen in cases where replacement of the component 151 is more difficult and costly than replacing the entire assembly.

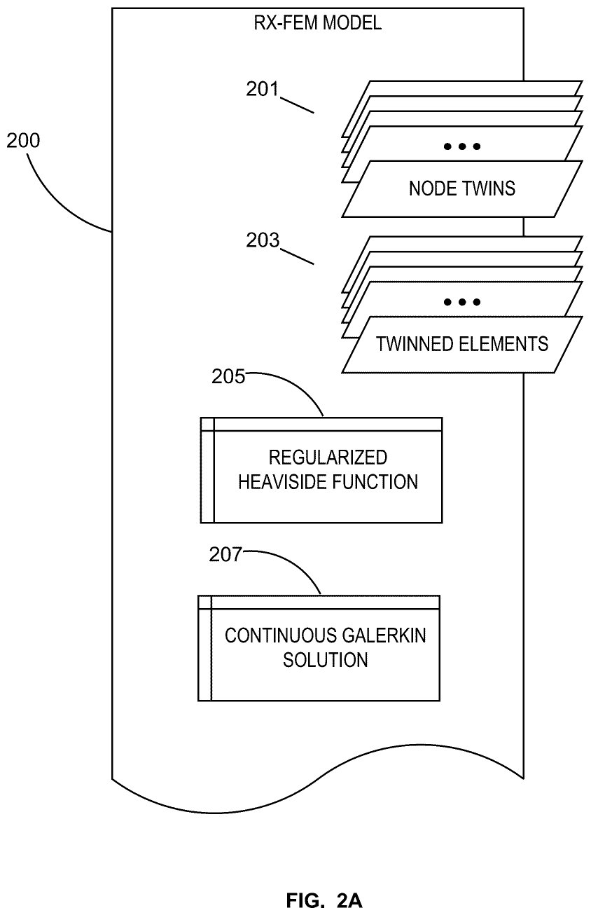

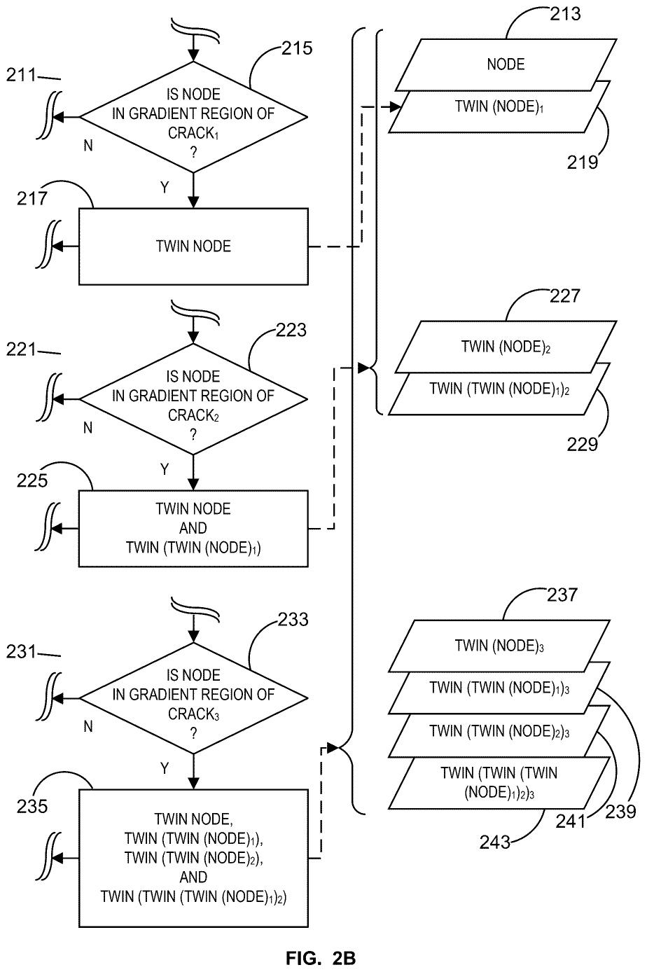

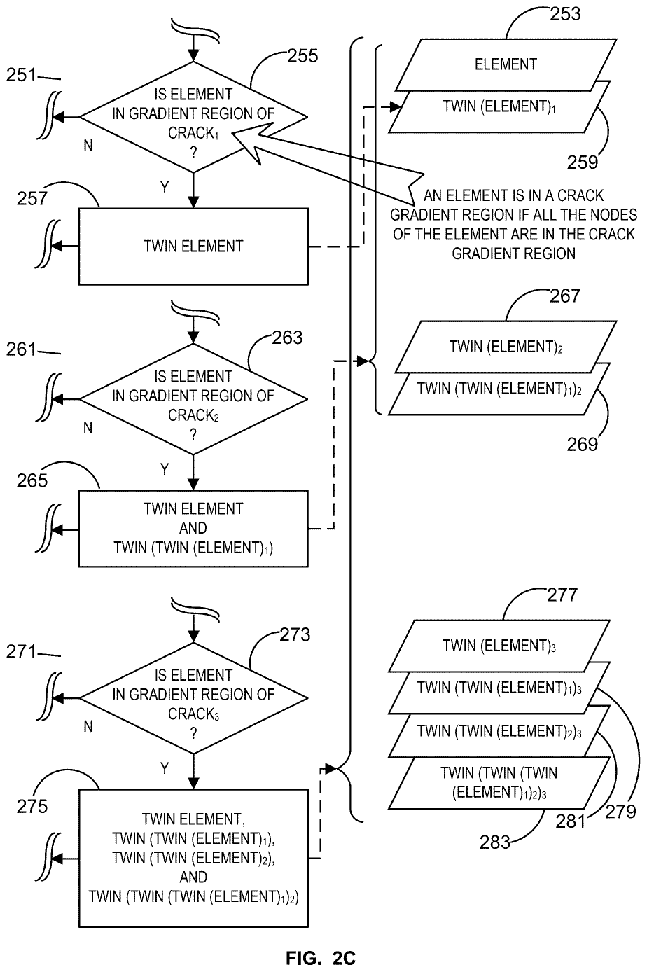

FIG. 2A schematically illustrates a regularized extended Finite Element Method (RX-FEM) model 200 according to embodiments of the present invention, including a plurality of node twins 201 and a plurality of twinned elements 203 It is noted that twinned nodes 201 and twinned elements 203 are related to cracks in a modeled object, and are in addition to nodes and elements which are not related to cracks and which are therefore not twinned. Model 200 includes a regularized (continuous) Heaviside function 205 and is characterized as having a well-known continuous Galerkin solution 207.

The introduction of node twins 201 and twinned elements 203 is done via the following steps:
Calculate a regularized (continuous) Heaviside function for each crack independently. For the Finite Element Method details disclosed in the Appendix (as previously incorporated by reference to U.S. Provisional Application No. 63/745,757, filed Jan. 15, 2025), this involves calculating the signed distance field, using Equation (4) to compute the coefficients for the regularized Heaviside function, and using finite element shape functions to interpolate the regularized Heaviside function according to the computed coefficients.
Identify the elements for each crack over which the regularized Heaviside function is changing values and identify the set of connected nodes to those identified elements.
Extend the identified nodes and elements hierarchically through a recursive procedure. When an extension for a regularized Heaviside function is introduced to a node, create new copies (the “node twins”) of the node, as discussed in detail below. Importantly, a new pair of node “twins” is generated for each existing node “twin”. That is, for each node associated with intersecting cracks, there will be 2^{N} versions of the node (including the original existing node), where N is the number of cracks which intersect in the gradient region of the original existing node. Twinned elements are extended following a similar process (FIG. 2C), with the additional step of determining the node connectivity for each copy of the element. The recursive hierarchical extension process for elements can be conceptualized as a “perfect binary tree” of extensions, where each level in the binary tree represents a crack of a set of intersecting cracks. The important implication of this technique is that given a regularized crack in an element, both sides of a first crack are twinned for a second crack subsequently introduced in the same element, as well as for a third crack later introduced, and so forth, for an arbitrary number of N intersecting cracks.
Finally, an updated solution is computed, according to new boundary conditions or extensions. This typically involves solving the global system of equations by accumulating the contribution from each element twin and the contribution from interfacial forces that may exist between every combination of two twins in an element. The interfacial forces account for phenomena occurring along the crack surface, such as cohesive forces if a cohesive zone model is used for cracks or opening pressure due to a fluid.

FIG. 2B conceptually illustrates a recursive series of steps for creating a hierarchical set of new “twinned” nodes, for analyzing intersecting cracks according to embodiments of the present invention.

It is first noted that the addition of new “phantom” nodes in Finite Element Analysis is well-known in the field. However, the addition of new “twin” nodes according to the disclosure herein (illustrated in FIG. 2B) in keeping with the recursive procedure described, illustrated, and claimed herein for recursively constructing a hierarchical set of twinned nodes combined with regularized Heaviside functions to analyze intersecting cracks is a novel and inventive feature of the present invention which is neither anticipated nor fairly suggested by the prior art “phantom” nodes.

According to embodiments of the present invention, “twinning” an existing node associated with a first crack (by being located on one side of the first crack) involves creating a “twin” node corresponding to the existing node, but located on the other side of the first crack. Where a second crack also includes the same existing node (located on one side of the second crack), the node twinning involves creating a node twin on the other side of the second crack. In addition, however, not only is the original node twinned for the second crack, but the twin of the original node associated with the first crack is also twinned for the second crack. This recursive property and the hierarchical result are illustrated in detail in FIG. 2B along with the related discussion below.

For simplicity and clarity of presentation, FIG. 2B illustrates the steps for twinning nodes lying in the gradient regions in an intersection of three (3) successively-intersecting cracks. Based on the presentation of FIG. 2B, it is straightforward to extend this node twinning procedure according to embodiments of the present invention for analyzing an arbitrary number of N intersecting cracks.

FIG. 2B shows that at each recursive level i corresponding to the intersecting cracks (i=1, 2, 3), there are a total of 2ⁱ twinned nodes, counting the originally-existing node from which all the added twins are derived. As just noted above, it is straightforward to extend this to i=1, 2, 3, ..., N.

In FIG. 2B, a data processing procedure section 211 includes a node datum 213, which specifies the parameters of an existing node (denoted as NODE 213), for data processing of the node in an extended Finite Element model. In a decision point 215, it is checked to see if the existing node lies within the gradient region of a first crack denoted as CRACK₁. If NODE 213 is not in the gradient region of CRACK₁ (decision “N”), then no action is taken. If, however, NODE 213 does lie in the gradient region (decision “Y”), then in a step 217, NODE 213 is twinned to create a new node TWIN (NODE)₁ in a datum 219. Thus, for the first twinning iteration, i=1, and as expected there are 2ⁱ=2 nodes—original NODE 213 in datum 213 and TWIN (NODE)₁ in datum 219.

From an analytic viewpoint, it is noted that, due to the use of the regularized Heaviside function, a node twin on one side of a crack can affect displacements on the other side of the crack, and in this manner, taking the twin node into account contributes to analysis of the crack and how it affects the integrity of the solid object being modeled.

Continuing with FIG. 2B, in a data processing procedure section 221, a decision point 223 checks to see if the existing node lies within the gradient region of a second crack denoted as CRACK₂. If NODE 213 is not in the gradient region of CRACK₂ (decision “N”), then no action is taken. If, however, NODE 213 does lie in the gradient region (decision “Y”), then in a step 225, NODE 213 is twinned to create a new node TWIN (NODE)₂ in a datum 227. In addition, previously-added new node TWIN (NODE)₁ 219 from procedure section 211 is recursively twinned to create a new node TWIN (TWIN (NODE)₁)₂ in a datum 229. At this point after the second twinning iteration, i=2, and as expected there are 2ⁱ=4 nodes-original NODE 213, TWIN (NODE)₁ in datum 219, TWIN (NODE)₂ in datum 227, and TWIN (TWIN (NODE)₁)₂ in datum 229.

Further continuing with FIG. 2B, in a data processing procedure section 231, a decision point 233 checks to see if the existing node lies within the gradient region of a third crack denoted as CRACK₃. If NODE 213 is not in the gradient region of CRACK₃ (decision “N”), then no action is taken. If, however, NODE 213 does lie in the gradient region (decision “Y”), then in a step 235, NODE 213 is twinned to create a new node TWIN (NODE)₃ in a datum 237. In addition, previously-added new node TWIN (NODE)₁ 219 from procedure section 211 is recursively twinned to create a new node TWIN (TWIN (NODE)₁)₃ in a datum 239; TWIN (NODE)₂ 227 from procedure section 221 is recursively twinned to create a new node TWIN (TWIN (NODE)₂)₃ in a datum 241; and previously-added new node TWIN (TWIN (NODE)₁)₂ 229 is recursively twinned to create a new node TWIN (TWIN (TWIN (NODE)₁)₂)₃ in a datum 243. Here, i=3 and, as expected, there are a total of 2ⁱ=8 twinned nodes in all.

Another novel and inventive feature of the present invention relates to the twinning of elements in an eXtended Finite Element Method model. FIG. 2C conceptually illustrates a recursive series of steps for creating a hierarchical set of new twinned elements, for analyzing intersecting cracks according to embodiments of the present invention.

If all the nodes of an element are located in the gradient region of a crack, then the element is also considered to lie in the gradient region of the crack. According to related embodiments of the present invention, if substantially all of the nodes of the element lie within the gradient region of a crack, then the element is also considered to lie in the gradient region of the crack.

The addition of new “twin” elements according to the disclosure herein (illustrated in FIG. 2C) in keeping with the recursive procedure described, illustrated, and claimed herein for constructing a hierarchical set of twinned elements to analyze intersecting cracks is a novel and inventive feature of the present invention.

According to embodiments of the present invention, “twinning” an existing element associated with a first crack (by being located on one side of the first crack) involves creating a “twin” element corresponding to the existing element, but located on the other side of the first crack. Where a second crack also includes the same existing element (located on one side of the second crack), the twinning involves creating a twin element on the other side of the second crack. In addition, however, not only is the original element twinned for the second crack, but the twin of the original element associated with the first crack is also twinned for the second crack. This recursive property and the hierarchical result are illustrated in detail in FIG. 2C along with the related discussion below.

For simplicity and clarity of presentation, FIG. 2C illustrates the steps for twinning elements lying in the gradient regions in an intersection of three (3) successively-intersecting cracks. Based on the presentation of FIG. 2C, it is straightforward to extend this element twinning procedure according to embodiments of the present invention for analyzing an arbitrary number of N intersecting cracks.

FIG. 2C shows that at each recursive level i corresponding to the intersecting cracks (i=1, 2, 3), there are a total of 2ⁱ twinned elements, counting the originally-existing element from which all the added twins are derived. As just noted above, it is straightforward to extend this to i=1, 2, 3, ..., N.

In FIG. 2C, a data processing procedure section 251 includes an element datum 253, which specifies the parameters of an existing element (denoted as ELEMENT 253), for data processing of the element in an extended Finite Element model. In a decision point 255, it is checked to see if the existing element lies within the gradient region of a first crack denoted as CRACK₁. If ELEMENT 253 is not in the gradient region of CRACK₁ (decision “N”), then no action is taken. If, however, ELEMENT 253 does lie in the gradient region (decision “Y”), then in a step 257, ELEMENT 253 is twinned to create a new element TWIN (ELEMENT)₁ in a datum 259. Thus, for the first twinning iteration, i=1, and as expected there are 2ⁱ=2 elements-original ELEMENT 253 in datum 253 and TWIN (ELEMENT)₁ in datum 259.

From an analytic viewpoint, it is noted that, due to the use of the regularized Heaviside function, an element twin on one side of a crack can affect displacements on the other side of the crack, and in this manner taking into account the twin element contributes to analysis of the crack and how it affects the integrity of the solid object being modeled.

Continuing with FIG. 2C, in a data processing procedure section 261, a decision point 263 checks to see if the existing element lies within the gradient region of a second crack denoted as CRACK₂. If ELEMENT 253 is not in the gradient region of CRACK₂ (decision “N”), then no action is taken. If, however, ELEMENT 253 does lie in the gradient region (decision “Y”), then in a step 265, ELEMENT 253 is twinned to create a new element TWIN (ELEMENT)₂ in a datum 267. In addition, previously-added new element TWIN (ELEMENT)₁ 259 from procedure section 251 is recursively twinned to create a new element TWIN(TWIN (ELEMENT)₁)₂ in a datum 269. At this point after the second twinning iteration, i=2, and as expected there are 2ⁱ=4 elements-original ELEMENT 253, TWIN (ELEMENT)₁ in datum 259, TWIN (ELEMENT)₂ in datum 267, and TWIN (TWIN (ELEMENT)₁)₂ in datum 269.

Further continuing with FIG. 2C, in a data processing procedure section 271, a decision point 273 checks to see if the existing element lies within the gradient region of a third crack denoted as CRACK₃. If ELEMENT 253 is not in the gradient region of CRACK₃ (decision “N”), then no action is taken. If, however, ELEMENT 253 does lie in the gradient region (decision “Y”), then in a step 275, ELEMENT 253 is twinned to create a new element TWIN (ELEMENT)₃ in a datum 277. In addition, previously-added new element TWIN (ELEMENT)₁ 259 from procedure section 251 is recursively twinned to create a new element TWIN (TWIN (ELEMENT)₁)₃ in a datum 279; TWIN (ELEMENT)₂ 267 from procedure section 261 is recursively twinned to create a new element TWIN (TWIN (ELEMENT)₂)₃ in a datum 281; and previously-added new element TWIN (TWIN (ELEMENT)₁)₂ 269 is recursively twinned to create a new element TWIN (TWIN (TWIN (ELEMENT)₁)₂)₃ in a datum 283. Here, i=3 and, as expected, there are a total of 2ⁱ=8 twinned elements in all.

In the embodiments described above, the recursive methods result in respective associated hierarchies of twinned nodes and twinned elements, wherein a hierarchy of twinned nodes includes multiply-twinned nodes; and a hierarchy of twinned elements includes multiply-twinned elements. In related embodiments of the present invention, eXtended Finite Element Method models include multiple intersecting virtual cracks and/or multiple hypothetical intersecting cracks for analyzing prospective fracturing of objects in a manufacturing process, structures being examined during maintenance, and so forth. In various embodiments of the present invention, related models of objects analyzed during manufacture and/or maintenance include such virtual or hypothetical intersecting cracks for purposes of analysis and failure prediction. In these embodiments there are no computational, procedural, notational, or nomenclature differences between real intersecting cracks and virtual or hypothetical intersecting cracks when working with or analyzing the respective extended Finite Element Method models.

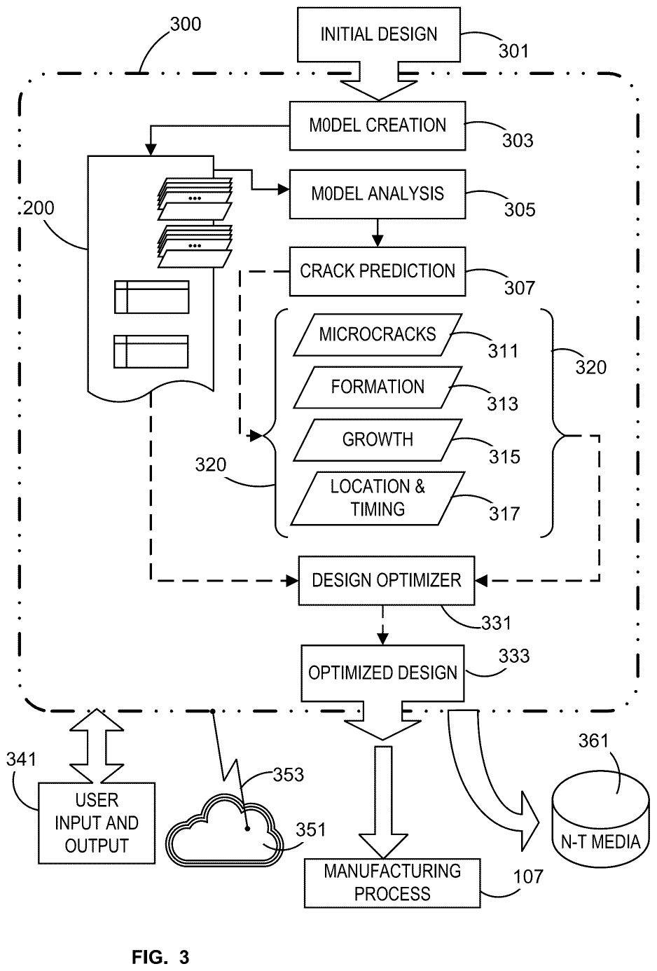

FIG. 3 shows a flowchart of a manufacturing method 300 according to an embodiment of the present invention, and also schematically shows modules related to the manufacturing process illustrated in FIG. 1A.

Starting with an initial design 301 for the material solid object as a manufactured item, a model creation module 303 creates RX-FEM model 200 having node twins and twinned elements as previously described. A model analysis module 305 then analyzes model 200 and a crack prediction module 307 develops crack predictions 320, which may include predictions of microcracks 311, crack formations 313, crack growth 315, and locations and timing thereof 317. Next, a design optimizer module 331 outputs an optimized design 333 based on predictions 320. Optimized design 333 corresponds to a version of initial design 301 in meeting the external and stress/load requirements of initial design 301 while having optimal resistance to crack formation and crack growth according to model 200 as analyzed by model analysis module 305, Optimized design 333 is then input to manufacturing process 107 for fabrication of the improved material solid object.

The manufacturing process of FIG. 3 also features user input and output 341 for operation of manufacturing process 107.

According to a related embodiment of the present invention, manufacturing method steps 300 are performed by a data processor over a data network 351 via a data link 353. In another related embodiment, manufacturing method steps 300 are performed by local data processor 105 according to machine-readable executable instructions stored in a non-transitory data storage media 361.

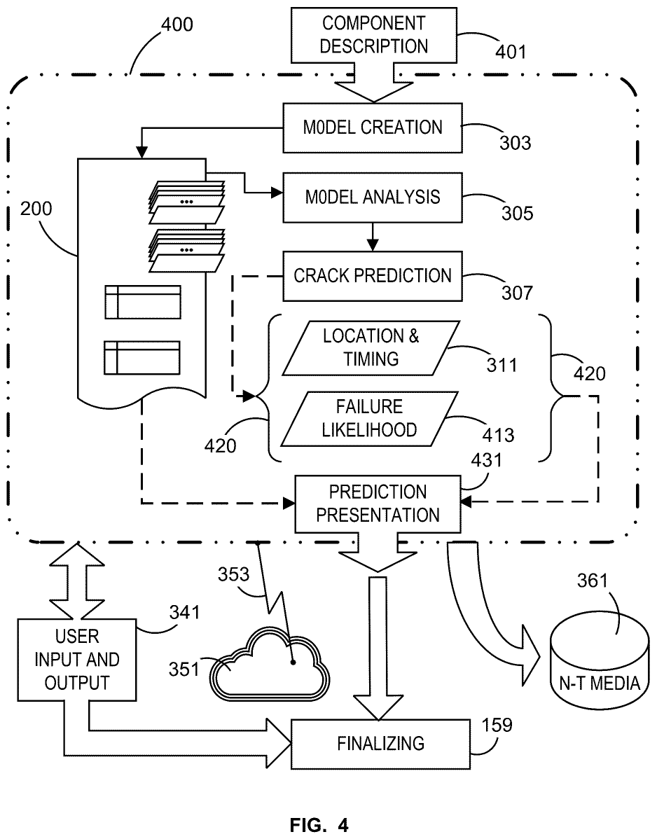

FIG. 4 shows a flowchart of a preventative maintenance method 400 according to an embodiment of the present invention, and also schematically shows modules related to the inspection—preventative maintenance process illustrated in FIG. 1B.

Starting with a component description 401 for crack-affected material solid object 151, model creation module 303 creates RX-FEM model 200 having node twins and twinned elements as previously described. Model analysis module 305 then analyzes model 200 and crack prediction module 307 develops crack predictions 420, which may include predictions of locations of crack growth and timing thereof 311, and an estimate of failure likelihood 413. Finally, prediction presentation module 431 outputs a recommendation for finalizing 159 based on predictions 420. Recommendations allow user input and output 341 to determine the outcome of the preventative maintenance operation, as shown in FIG. 1B.

As before, according to a related embodiment of the present invention, preventative maintenance method steps 400 are performed by a data processor over a data network 351 via a data link 353. In another related embodiment, preventative maintenance method steps 400 are performed by local data processor 105 according to machine-readable executable instructions stored in a non-transitory data storage media 361.

1. A method for manufacturing a material solid object based on a pre-determined initial design, wherein the material solid object is potentially-susceptible to crack-induced fracture, the method comprising:
creating a finite element mesh model of the material solid object based on the initial design, wherein the finite element mesh model includes a plurality of node twins and a plurality of twinned elements;
using the finite-element mesh model with node twins and twinned elements to obtain a prediction of at least one of:
a micro-crack formation in the material solid object, and
a location and timing of a crack propagation in the material solid object;
optimizing the initial design according to the prediction, to obtain an optimized design which inhibits at least one of:
crack formation in the material solid object, and
crack growth in the material solid object; and
fabricating the material solid object according to the optimized design.

2. The method of claim 1, wherein the finite element mesh model further comprises a regularized Heaviside function.

3. The method of claim 1, wherein the finite element mesh model further comprises a cohesive zone model for at least one pair of twinned elements.

4. The method of claim 1, wherein the finite element mesh model further comprises a continuous Galerkin solution for a mesh-independent crack.

5. The method of claim 1, wherein the material of the material solid object is one of:
a brittle material;
a quasi-brittle material.

6. The method of claim 1, wherein the material of the material solid object is a composite material.

7. The method of claim 6, wherein the material of the material solid object is a laminate.

8. The method of claim 1, wherein the material solid object is included within a structure.

9. The method of claim 8, wherein the structure is selected from a group consisting of:
a building;
a road;
a bridge;
an overpass;
a tunnel;
a tower; and
a monument.

10. The method of claim 1, wherein the material solid object is a component within an assembly.

11. The method of claim 10, wherein the assembly is selected from a group consisting of:
a system;
a device;
a machine; and
a vehicle. Page 4

12. The method of claim 11, wherein the vehicle is selected from a group consisting of:
a terrestrial vehicle;
a railway vehicle;
a cable vehicle;
an amphibious vehicle;
an autonomous vehicle;
a cargo vehicle;
a lifting carrier;
a hovercraft;
an aircraft;
a launch vehicle;
a spacecraft;
a waterborne vessel;
a ship;
a submarine vessel; and
a submersible vessel.

13. The method of claim 1, wherein at least one of:
the creating a finite element mesh model,
the using the finite element mesh model, and
the optimizing the initial design
is performed by a data processor according to executable instructions stored on a non-transitory data storage medium.

14. (canceled)

15. A method for preventative maintenance of an assembly including a material solid component, wherein the material solid component has at least one existing crack, the method comprising:
creating a finite element mesh model of the material solid component wherein
the finite element mesh model includes a plurality of node twins and a plurality of twinned elements;
using the finite-element mesh model with node twins and twinned elements to obtain a prediction of at least one of:
a location and timing of a crack growth in the material solid component, and
a measure of a failure likelihood of the material solid component;
and, based on the prediction, finalizing the preventative maintenance by performing at least one of the following:
certifying the worthiness of the material solid component,
scheduling a future inspection of the material solid component,
conducting a restorative procedure on the material solid component,
replacing the material solid component, and
scrapping the assembly.

16.-21. (canceled)

22. The method of claim 15, wherein the material solid object is included within a structure.

23. The method of claim 22, wherein the structure is selected from a group consisting of:
a building;
a road;
a bridge;
an overpass;
a tunnel;
a tower; and
a monument.

24. (canceled)

25. The method of claim 24, wherein the assembly is selected from a group consisting of:
a system;
a device;
a machine; and
a vehicle.

26. The method of claim 25, wherein the vehicle is selected from a group consisting of:
a terrestrial vehicle;
a railway vehicle;
a cable vehicle;
an amphibious vehicle;
an autonomous vehicle;
a cargo vehicle;
a lifting carrier;
a hovercraft;
an aircraft;
a launch vehicle;
a spacecraft;
a waterborne vessel;
a ship;
a submarine vessel; and
a submersible vessel.

27. The method of claim 15, wherein at least one of:
the creating a finite element mesh model, and
the using the finite element mesh model to obtain a prediction
is performed by a data processor according to executable instructions stored on a non-transitory data storage medium.

28. The method of claim 15, wherein at least one of:
the creating a finite element mesh model, and
the using the finite element mesh model to obtain a prediction
is performed by a data processor over a data network.
